(19) United States
(12) Patent Application Publication
(10) Pub. No.: US 2013/0118285 A1
(43) Pub. Date: May 16, 2013

(54) SHIFT TOWER WITH DECOUPLED MASS

(71) Applicants: Rogerio Martins Fernandes, SAO BERNARDO DO CAMPO (BR); Edmar Jose Pereira Gomes, SAO JOSE DOS CAMPOS (BR)

(72) Inventors: Rogerio Martins Fernandes, SAO BERNARDO DO CAMPO (BR); Edmar Jose Pereira Gomes, SAO JOSE DOS CAMPOS (BR)

(73) Assignee: GM GLOBAL TECHNOLOGY OPERATIONS LLC, DETROIT, MI (US)

(21) Appl. No.: 13/295,773

(22) Filed: Nov. 14, 2011

(51) Int. Cl. F16H 59/04

(52) U.S. Cl. 74/473.33

(57) ABSTRACT

A shift assembly for a manual transmission includes a decoupled inertial mass. The decoupled mass is active only to assist and complete the shift (longitudinal shift lever movement) and is inactive during selection (lateral shift lever motion). A shift tower includes a stub shaft which is translated axially by a first shift cable through a first linkage. This motion corresponds to lateral motion of the shift lever (selection). A radial arm is rotated by a second shift cable through a second linkage. This motion corresponds to longitudinal motion (gear engagement) of the shift lever. A mass of dense material is mounted on the arm which is received about the stub shaft and connected thereto by a member in a slot that rotationally couples the arm and mass to the stub shaft but allows unrestricted (uncoupled) axial motion between the arm (and mass) and the stub shaft.

### FIELD

The present disclosure relates to a shift tower for a manual transmission and more particularly to a shift tower for a manual transmission having a decoupled inertial mass.

### BACKGROUND

The statements in this section merely provide background information related to the present disclosure and may or may not constitute prior art.

Notwithstanding myriad improvements to the operation and performance of automatic transmissions, there remain vehicle purchasers who prefer the control and enhanced driving experience provided by manual transmissions. Manual transmission aficionados praise their visceral connection and throughput from the vehicle to the driver.

It is not surprising then that efforts to improve the operation of manual transmissions continue. One of the areas of continued development relates to the shift tower and shift lever which are, ultimately, the interface between the driver and the transmission.

For example, in order to provide a more positive, defined and distinct feel to the shift lever, it has been suggested that a mass of dense material, such as lead, be added to the base of the shift lever. Once accelerated, the momentum of the mass assists positive engagement of a gear by providing additional energy to move the shift lever to the end of a shift pattern slot. This approach is not without a drawback, however, the drawback being the amount of energy that must be expended by the driver to initiate motion of the shift lever from its center or neutral position. More specifically, the energy expended by the driver and absorbed by the mass during lateral motion of the shift lever, referred to as “selection,” has little impact on and does not significantly contribute to improved shift feel. That is, only mass assisted longitudinal motion of the shift lever, referred to as “shift,” improves the feel and positiveness of the overall shift. A corollary to this drawback is the energy that must be expended by the driver to negotiate complex, e.g., U-shaped, shift patterns with a mass loaded shift lever. Again, the energy expended and absorbed to move the shift laterally does not provide any appreciable improvement of shift feel.

It is therefore apparent that improvements to the shift lever art directed to improving shift feel are desirable.

### SUMMARY

The present invention provides a shift assembly for a manual transmission that includes a decoupled inertial mass. The decoupled mass is active only for engagement and to assist and drive home the shift (longitudinal motion of the shift lever) rather than to require additional operator effort during the selection (lateral motion) portion of the shift process. The shift tower includes a shaft or stub shaft which is translated axially by a first shift cable through a first linkage. This motion is generated by and corresponds to lateral motion of the shift lever (selection). A mass of material such as metal or other dense material is mounted on an outer end of an arm which rotates about the axis of the stub shaft. A second shift cable is connected through a second linkage to the arm and rotates the arm in response to longitudinal motion (gear engagement) of the shift lever (shift). The stub shaft and the arm are connected by an offset member or extension coupled to the stub shaft which is received in a slot in the arm. Thus the mass moves (pivots about the stub shaft axis) during motion of the second shift cable and gear engagement (shift) but does not move during motion of the first shift cable, axial motion of the stub and gear selection. In this way, the added gear shifting or engaging force provided by the mass only affects (is coupled to) rotation of the stub shaft and thus gear engagement (shifting), not gear selection.

Thus it is an aspect of the present invention to provide a shift tower having improved gear shifting feel.

It is a further aspect of the present invention to provide a shift tower having a mass which is coupled to the shift lever for gear engagement (shifting) action but is uncoupled from the shift lever for gear selection action.

It is a still further aspect of the present invention to provide a shift tower having a mass which is active during gear engagement (shifting) action but is inactive during gear selection action.

It is a still further aspect of the present invention to provide a shift tower having a stub shaft which translated axially for gear selection and rotates for gear shifting.

It is a still further aspect of the present invention to provide a shift tower having a shaft and an arm with a mass at one end which is attached to the shaft by means which couple the arm for rotation with the shaft but decouple the arm from the shaft upon axial motion of the shaft.

It is a still further aspect of the present invention to provide a shift tower having a shift assisting mass which is coupled to a shift lever by a pair of cables.

Further aspects, advantages and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a diagrammatic view of a manual transmission and shift tower assembly coupled to a shift lever by a pair of shift cables;

FIG. 2 is a perspective view of a shift tower assembly incorporating the present invention;

FIG. 3 is a full sectional view of a shift tower assembly incorporating the present invention;

FIG. 4 is a side, elevational view of a shift tower assembly incorporating the present invention illustrating the transmission shift forks.

### DETAILED DESCRIPTION

The following description is merely exemplary in nature and is not intended to limit the present disclosure, application, or uses.

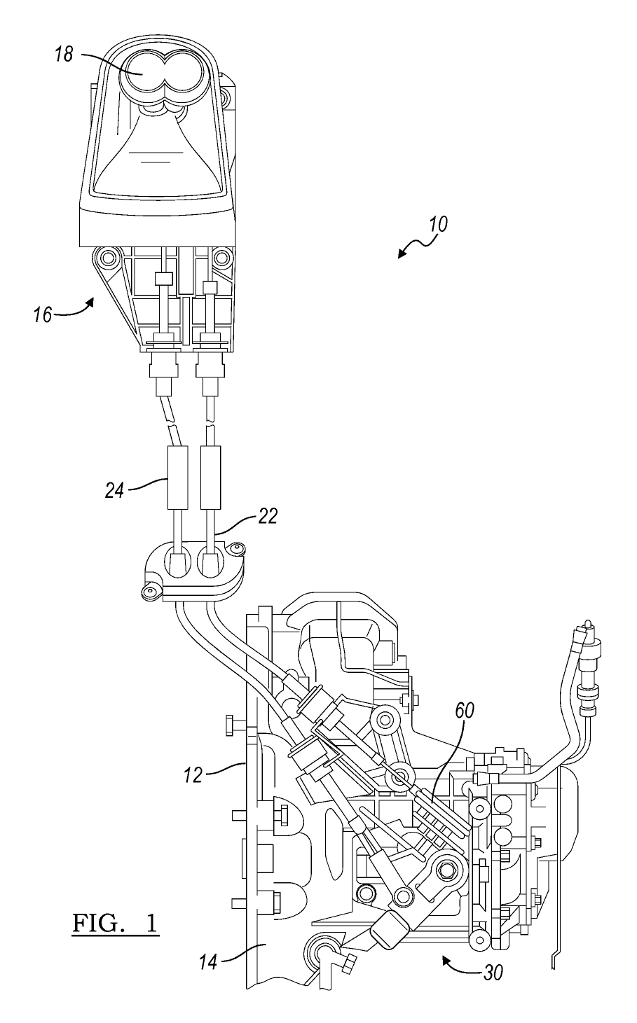

With reference now to FIG. 1, a typical motor vehicle manual transmission and shift assembly according to the present invention are illustrated and generally designated by the reference number 10. The manual transmission and shift assembly 10 include a transmission 12 having a housing 14 and a shift lever assembly 16 having a shift lever 18 which is linked to the transmission 12 by a first, selection cable 22 and a second, shift cable 24. The first, selection cable 22 transmits lateral (selection) motion of the shift lever 18 to the transmission 12 and the second, shift cable 24 transmits longitudinal (shift) motion of the shift lever 18 to the transmission 12. If desired, a shift gate (not illustrated) may be operatively associated with the shift lever 18 to define and guide its driver commanded motion through an “H” or extended “H” pattern.

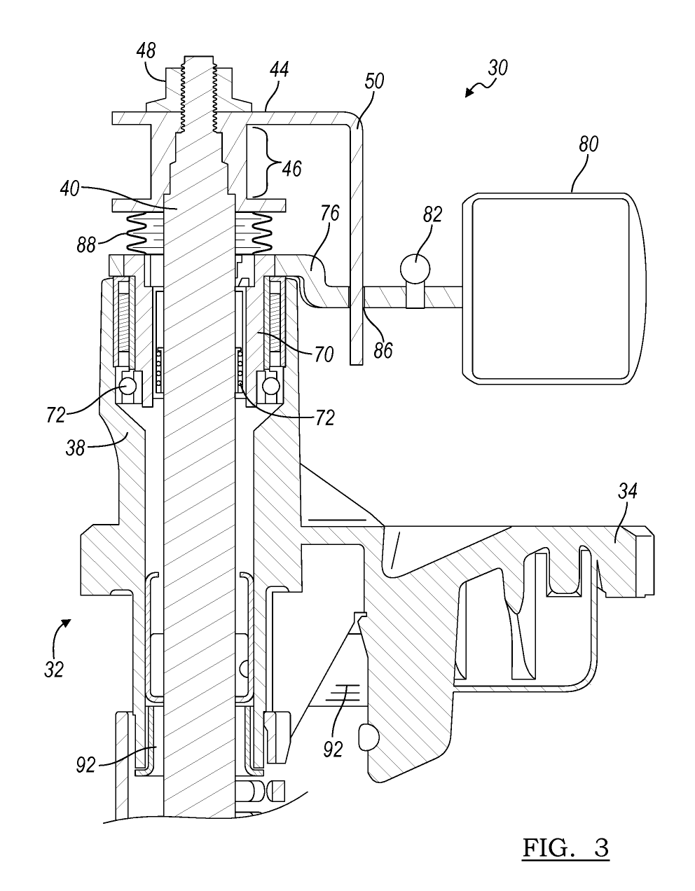

Referring now to FIGS. 1, 2 and 3, secured to the top of the transmission housing 14 is a shift tower assembly 30. The shift tower assembly 30 includes a shift tower housing 32 including a generally flat plate 34 that is disposed upon and conforms to the transmission housing 14. The flat plate 34 of the shift tower housing 32 may be secured to the transmission housing 14 by a plurality of, for example, threaded fasteners (not illustrated) which extend through a like plurality of bores or openings 36. The shift tower housing 32 also includes a hollow cylindrical or tubular tower 38 which slidably and rotatably receives a shaft or stub shaft 40.

At the top of the stub shaft 40 resides a bobbin, collar or hub 44 that defines a circumferential channel or groove 46. The collar or hub 44 is secured to and retained on the stub shaft 40 by a nut 48 or similar fastener and rotates therewith. The upper portion of the collar or hub 44 defines or includes a right angle member, extension or lever arm 50 that extends first radially outwardly and then parallel to the stub shaft 40. Residing within the channel or groove 46 is a follower block 52 that is coupled through a ball and socket joint 54 to one end of a crank arm assembly 60. At the center of the crank arm assembly 60 is secured a shaft 62 which is received within a pair of bearings 64. Thus, the crank arm assembly 60 is free to pivot about the axis of the shaft 62 while supported and retained within the bearings 64. At the other end of the crank arm assembly 60 is disposed another ball and socket joint 66. The first, selection cable 22 (illustrated in FIG. 1) is connected through the ball and socket joint 66 to the crank arm assembly 60. Thus, motion of the first, selection cable 22 is transferred through the crank arm assembly 60 and translates the stub shaft 40 axially in response to lateral (selection) motion of the shift lever 18 (also illustrated in FIG. 1).

Disposed within the tubular tower 38, between the tower 38 and the stub shaft 40 is a quill or tubular member 70. The quill or tubular member 70 is preferably rotationally supported both on its inner and outer surfaces by a suitable plurality of anti-friction bearings 72 such as ball or roller bearing assemblies. To the upper end of the quill or tubular member 70 is secured a radial arm 76. The radial arm 76 extends outwardly from the quill or tubular member 70 and, at its end most distant therefrom, resides an inertial mass or weight 80. The mass or weight 80 is preferably fabricated of a dense material such as a metal and preferably weighs several ounces. Between the quill or tubular member 70 and the mass 80, and preferably closer to the mass 80 is a ball 82 of a ball and socket joint 84 through which the second, shift cable 24 is coupled to the radial arm 76. The radial arm 76 also includes an opening or slot 86, preferably located between the quill or member 70 and the ball 82 which is complementary to and receives the end of the right angle shift lever member, extension or arm 50. Thus, motion of the second, shift cable 24 is transferred through the right angle shift lever arm 50 and rotates the stub shaft 40 about its axis in response to longitudinal (shift) motion of the shift lever 18.

A bellows 88, preferably fabricated of an elastomeric material, extends between the lower portion of the bobbin, collar or hub 40 and the upper surface of the radial arm 76 and provides a seal therebetween that prevents foreign material from entering and fouling the shift tower assembly 30. A spring biased detent assembly 92 engages suitable recesses (not illustrated) in the stub shaft 40 and provides both tactile feedback to the operator of the vehicle when a gear has been positively and fully engaged and assists retention of the entire shift linkage in the selected gear as those familiar with detent assemblies will readily understand.

From the foregoing, it will be appreciated that whereas axial motion of the stub shaft 40 will not translate the radial arm 76 and the mass or weight 80 due to the freedom of the right angle shift lever arm 50 within the opening or slot 86, rotational motion of the radial arm 76 which is directly affected and controlled by motion of the second shift cable 24 will translate the mass or weight 80 and will thus affect the action of shifting, that is, actual gear engagement.

Thus, the mass or weight 80 is de-coupled from lateral (selection) motion of the shift lever 18 transferred to the shift tower assembly 30 but is coupled to longitudinal (shift) motion of the shift lever 18. Accordingly, the term “de-coupled” as utilized herein with regard to the overall invention and specifically the mass or weight 80 has this definition: de-coupled or unaffected by lateral (selection) movement of the shift lever 18 by coupled to and translated by longitudinal (shift) movement of the shift lever 18. From the foregoing definition, it should be apparent that “decoupled” does not mean totally or completely decoupled as this interpretation is manifestly illogical.

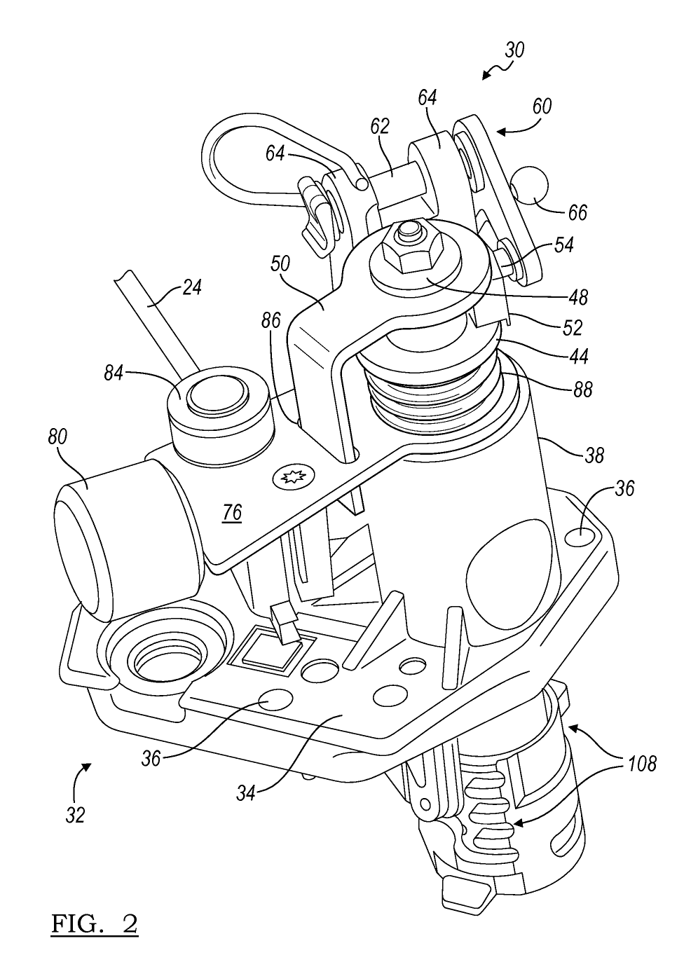

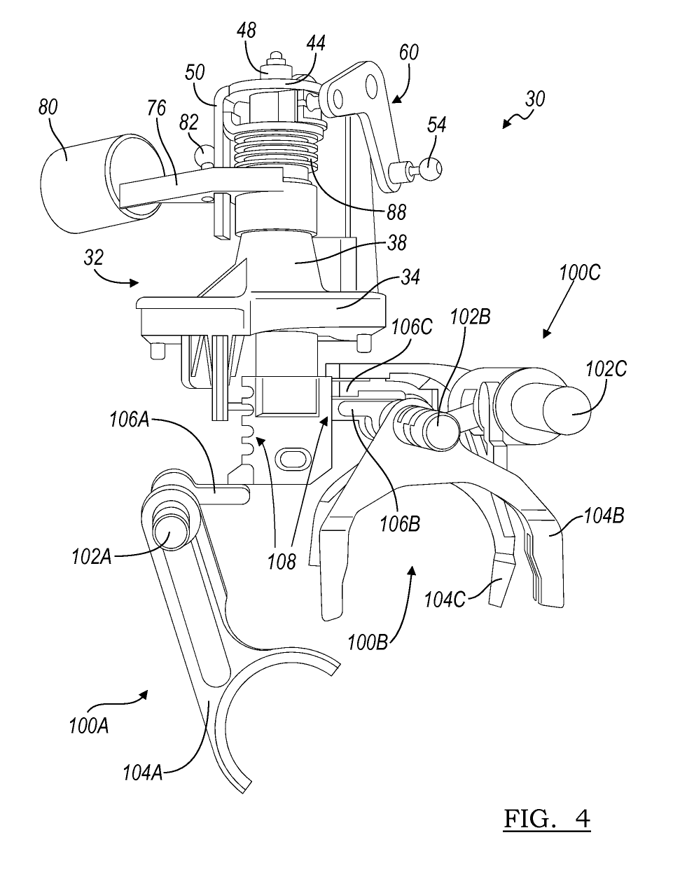

Referring now to FIGS. 2 and 4, the shift tower assembly 30 is associated with (typically) three shift assemblies 100A, 100B and 100C disposed within the transmission 12. Each of the three shift assemblies 100A, 100B and 100C includes a respective shift rail 102A, 102B and 102C. In a typical transmission 12 the shift rails 102A, 102B and 102C are parallel. Moreover, each of the shift rails 102A, 102B and 102C may be associated with one and typically two gears. For example, the shift rail 102A may be associated with first and second gears, the shift rail 102B may be associated with third and fourth gears and the shift rail 102C may be associated with fifth and reverse gears.

Attached to each of the shift rails 102A, 102B and 102C is a respective shift fork 104A, 104B and 104C. Each of the shift forks 104A, 104B and 104C are secured to a respective one of the shift rails 102A, 102B and 102C at a location where it aligns with, engages and translates a synchronizer clutch (not illustrated) which is associated with at least one, and typically, two gears. Also associated with each of the shift rails 102A, 102B and 102C, in a location proximate the shift tower assembly 30, such that they can be selectively engaged by one or more arms, lugs or fingers 108 on the stub shaft 40 is a respective channel, recess or slot 106A, 106B and 106C. The channels, recesses or slots 106A, 106B and 106C are arranged such that only one channel, recess or slot 106A, 106B and 106C associated with one of the shift rails 102A, 102B and 102C will be engaged in any one of the (typically) three axial positions of the stub shaft 40.

Stated somewhat differently, in any one axial position of the stub shaft 40, which corresponds to a defined lateral position of the shift lever 18, only one of the channels, recesses or slots 106A, 106B and 106C may be engaged with or by one of the arms, lugs or fingers 108 on the stub shaft 40. When the stub shaft 40 has been moved into an axial position which engages a specific channel, recess or slot 106A, 106B and 106C, longitudinal motion of the shift lever 18 which is carried through the second, shift cable 24 and the radial arm 76, rotates the stub shaft 40 and axially translates the selected one of the shift rails 102A, 102B and 102C to synchronize and engage a gear. During this action, the inertial mass or weight 80 is momentarily accelerated and moved angularly about the axis of the quill 70 and the stub shaft 40. The energy absorbed by the mass or weight 80 during the initial portion of the gear shifting and engaging activity is then released to assist and positively and completely engage the desired gear.

The description of the invention is merely exemplary in nature and variations that do not depart from the gist of the invention are intended to be within the scope of the invention. Such variations are not to be regarded as a departure from the spirit and scope of the invention.

What is claimed is:

1. A shift assembly for a manual transmission comprising, in combination,
a shift lever moveable along a first, selection path and a plurality of second, perpendicular shift paths,
a shift tower remote from said shift lever, said shift tower including a stub shaft, a radially extending arm and means for coupling said stub shaft and said radial arm rotationally while allowing axial travel therebetween,
first means for transferring motion along said first path of said shift lever to axial motion of said stub shaft of said shift tower,
second means for transferring motion along said second paths of said shift lever to rotational motion of said radial arm of said shift tower, and
a mass of material coupled to said radial arm for rotation therewith.

2. The shift assembly of claim 1 wherein said first means for transferring includes a cable and a crank arm having a first end connected to said cable, a second end engaging said stub shaft and a pivot disposed between said ends.

3. The shift assembly of claim 1 wherein said second means for transferring includes a cable and a lever arm extending from said stub shaft and wherein said cable is connected to said lever arm.

4. The shift assembly of claim 1 further including a detent mechanism for detenting axial and rotational positions of said stub shaft.

5. The shift assembly of claim 1 further including a plurality of shift rails each having a shift fork and means operatively disposed between said stub shaft and said shift rails for achieving selective, exclusive engagement of said shift rails by said stub shaft.

6. The shift assembly of claim 1 wherein said means for coupling is a member extending parallel to and offset from said stub shaft and engaging a slot in said radial arm.

7. The shift assembly of claim 1 further including a manual motor vehicle transmission and wherein said shift tower is mounted upon said manual motor vehicle transmission.

8. A shift assembly for a manual motor vehicle transmission comprising, in combination,
a shift lever disposed for motion along a first, lateral selection path and a plurality of second, longitudinal shift paths,
a shift tower remote from said shift lever, said shift tower including a shaft, a concentrically mounted arm and means for coupling said shaft and said arm rotationally and allowing relative axial travel between said shaft and said arm,
first means for transferring motion of said shift lever along said first path to axial motion of said shaft,
second means for transferring motion of said shift lever along said second paths to rotational motion of said arm, and
a mass coupled to said arm for movement therewith.

9. The shift assembly of claim 8 wherein said first means for transferring includes a cable and a crank arm having a first end connected to said cable, a second end engaging said shaft and a pivot disposed between said ends.

10. The shift assembly of claim 8 wherein said second means for transferring includes a cable and a lever arm extending from said shaft and wherein said cable is connected to said arm.

11. The shift assembly of claim 8 further including an arm extending from said quill and wherein said mass is secured to said arm.

12. The shift assembly of claim 8 wherein said means for coupling is a member coupled to and offset from said shaft and engaging a slot in said arm.

13. The shift assembly of claim 8 further including a manual motor vehicle transmission and wherein said shift tower is mounted upon said manual motor vehicle transmission.

14. A shift assembly for a manual motor vehicle transmission comprising, in combination,
a shift lever disposed for motion along a first, lateral selection path and a plurality of second, longitudinal shift paths,
a shift tower remote from said shift lever, said shift tower rotationally supporting a quill member and a radial arm coupled to said quill member, a stub shaft coaxially disposed within said quill member and means for rotationally coupling said stub shaft and said quill member and allowing axial motion between said quill member and said shaft,
a first cable for transferring motion of said shift lever along said first path to axial motion of said stub shaft of said shift tower,
a second cable for transferring motion of said shift lever along said second paths to rotational motion of said quill member and said radial arm, and
a mass coupled to said radial arm for movement therewith.

15. The shift assembly for a manual transmission of claim 14 further including a crank arm having a first end connected to said first cable, a second end engaging said stub shaft and a pivot disposed between said ends.

16. The shift assembly for a manual transmission of claim 14 wherein said means for rotationally coupling said stub shaft and said quill member includes an axial member offset from said stub shaft and received within an opening is said radial arm.

17. The shift assembly for a manual transmission of claim 14 further including a ball and socket joint connecting said second cable and said radial arm.

18. The shift assembly for a manual transmission of claim 14 further including a detent mechanism for detenting axial and rotational positions of said stub shaft.
